(19) United States
(12) Patent Application Publication
(10) Pub. No.: US 2026/0194737 A1
(43) Pub. Date: Jul. 9, 2026

(54) OPTICAL SYSTEM AND IMAGE PICKUP APPARATUS

(71) Applicant: CANON KABUSHIKI KAISHA, Tokyo (JP)

(72) Inventor: Yoshihisa TASHIRO, Tochigi (JP)

(21) Appl. No.: 19/556,243

(22) Filed: Mar. 4, 2026

Related U.S. Application Data
(63) Continuation of application No. PCT/JP2024/027074, filed on Jul. 30, 2024.

(30) Foreign Application Priority Data
Oct. 16, 2023 (JP) 2023-177953

(51) Int. Cl. G02B 17/08; G02B 5/18; G02B 27/00; H04N 23/55

(52) U.S. Cl. CPC G02B 17/08; G02B 5/1814; G02B 27/0012; G02B 27/0037; H04N 23/55; G02B 2005/1804

(57) ABSTRACT

An optical system reflects light from an object side by a first reflective surface and further reflects the light by a second reflective surface to guide the light to an image side. The optical system includes a diffractive surface or a metasurface having a controlled wavelength dispersion characteristic. A predetermined inequality is satisfied.

### CROSS-REFERENCE TO RELATED APPLICATIONS

This application is a Continuation of International Patent Application No. PCT/JP2024/027074, filed on Jul. 30, 2024, which claims the benefit of Japanese Patent Application No. 2023-177953, filed on Oct. 16, 2023, both of which are hereby incorporated by reference herein in their entirety.

### BACKGROUND

### Field of the Technology

The present disclosure relates to an optical system and an image pickup apparatus, such as a digital camera.

### Description of the Related Art

Optical systems for compact image pickup apparatuses are demanded to reduce the number of lenses in order to reduce an overall optical length. U.S. Patent Application Publication No. 2022/121016 discloses an optical system that reduces the number of lenses using a planar lens having a diffractive surface, and reduces the size by folding an optical path using two reflective surfaces. Japanese Patent No. 6778823 discloses an optical system in which an optical path is folded using two transmissive reflective surfaces to reduce an optical length.

### SUMMARY

An optical system according to one aspect of the present disclosure reflects light from an object side by a first reflective surface and further reflects the light by a second reflective surface to guide the light to an image side. The optical system includes a diffractive surface or a metasurface having a controlled wavelength dispersion characteristic. Let ν₀ be an Abbe number of the diffractive surface or the metasurface, the following inequality is satisfied:

−0.2<1/ν₀<0.2.

An image pickup apparatus having the above optical system also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIG. 2 is a longitudinal aberration diagram of the optical system according to Example 1.

FIG. 3 is a sectional view of an optical system according to Example 2.

FIG. 4 is a longitudinal aberration diagram of the optical system according to Example 2.

FIG. 5 is a sectional view of an optical system according to Example 3.

FIG. 6 is a longitudinal aberration diagram of the optical system according to Example 3.

FIG. 7 is a sectional view of an optical system according to Example 4.

FIG. 8 is a longitudinal aberration diagram of the optical system according to Example 4.

FIG. 9 is a sectional view of an optical system according to Example 5.

FIG. 10 is a longitudinal aberration diagram of the optical system according to Example 5.

FIG. 11 is a sectional view of an optical system according to Example 6.

FIG. 12 is a longitudinal aberration diagram of the optical system according to Example 6.

FIG. 13 is a sectional view of an optical system according to Example 7.

FIG. 14 is a longitudinal aberration diagram of the optical system according to Example 7.

FIG. 15 is a sectional view of an optical system according to Example 8.

FIG. 16 is a longitudinal aberration diagram of the optical system according to Example 8.

FIG. 17 is a sectional view of an optical system according to Example 9.

FIG. 18 is a spot diagram of the optical system according to Example 9.

FIG. 19 illustrates a configuration using polarization.

FIG. 20 illustrates an image pickup apparatus including any one of the optical systems according to Examples 1 to 9.

### DESCRIPTION OF THE EMBODIMENTS

Hereinafter, examples of the present disclosure will be described with reference to the drawings. Prior to describing Examples 1 to 9, matters common to each example will be explained.

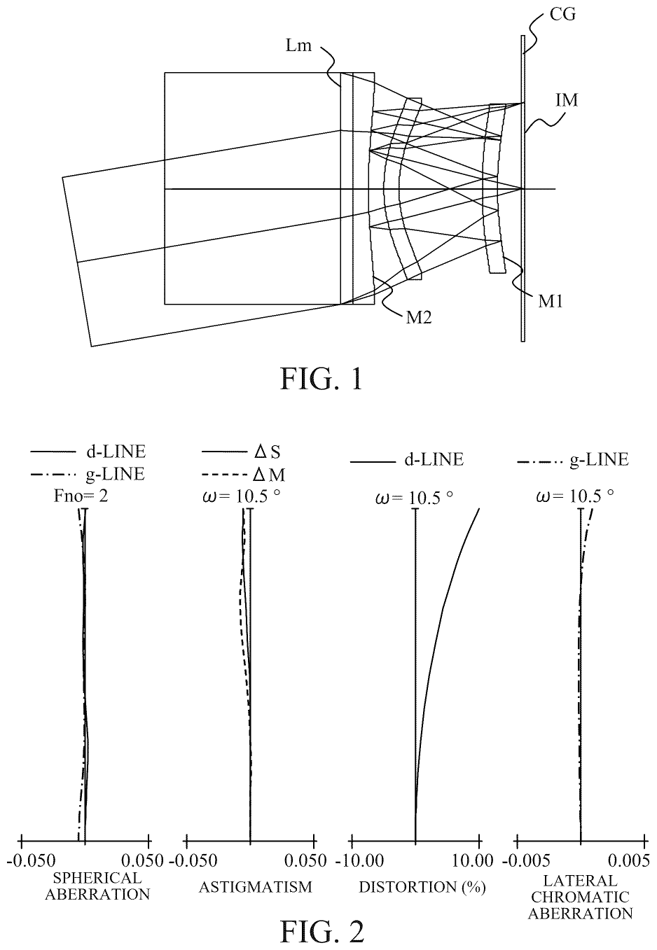

FIGS. 1, 3, 5, 7, 9, 11, 13, 15, and 17 illustrate configurations of optical systems according to Examples 1 to 9, respectively. The optical system according to each example is used as an imaging optical system in an image pickup apparatus such as a digital camera and film-based camera, and further in an image pickup apparatus installed in a smartphone, a tablet, and the like. In each figure, a left side is an object side and a right side is an image side.

In each example, Lm denotes a diffractive surface having a controlled wavelength dispersion characteristic (simply referred to as a “dispersion-controlled diffractive surface” hereinafter). M1 denotes a first reflective surface, and M2 denotes a second reflective surface. CG denotes a glass block corresponding to a cover glass, a low-pass filter, an IR-cut filter, or the like. IM denotes an image plane of the optical system. On the image plane IM, an imaging surface (light receiving surface) of an imaging element such as a CCD sensor or a CMOS sensor, or a photosensitive surface of a silver-halide film, is arranged.

The optical system according to each example is an optical system configured to guide light from an object side by reflecting the light on the first reflective surface M1 and further reflecting the light on the second reflective surface M2 toward the image side, and includes the dispersion-controlled diffractive surface Lm. Folding an optical path using the first and second reflective surfaces M1 and M2 can reduce an overall optical length of the optical system. In such an optical system, an Abbe number ν₀ of the dispersion-controlled diffractive surface Lm satisfies the following inequality (1):

$$- 0.2 < 1 / {v}_{0} < 0.2 \qquad ( 1 )$$

The Abbe number ν₀ of the dispersion-controlled diffractive surface Lm is defined as follows. Here, a reference wavelength is a d-line (λ_{d}=0.58756 μm), and primary dispersion is defined by an F-line (λF=0.48613 μm) and a C-line (λ_{C}=0.65627 μm). Optical path difference functions at the respective wavelengths are ψ(λ_{d}), ψ(λ_{F}), and ψ(λ_{C}). Optical path difference dispersions of the surface at the respective wavelengths are P(λ_{d}), P(λ_{F}), and P(λ_{C}). In this case, the following equation is satisfied:

$$\frac{1}{{v}_{o}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )}$$

The equation (1) is a condition relating to the wavelength dispersion characteristic of the dispersion-controlled diffractive surface Lm (corresponding to an Abbe number of a refractive lens), and indicates a proper range of 1/ν₀ for achieving both achromatism of the entire optical system and reduction in the number of lenses, thereby realizing high optical performance. In a case where 1/ν₀ is lower than the lower limit of inequality (1), the wavelength dispersion characteristic of the diffractive surface Lm becomes excessively high as a negative Abbe number, increasing chromatic aberration generated by the diffractive surface Lm. As a result, optical power of the diffractive surface Lm cannot be increased, making it difficult to reduce the size of the optical system and the number of lenses. In a case where 1/ν₀ becomes higher than the upper limit of inequality (1), the wavelength dispersion characteristic of the diffractive surface Lm becomes excessively high as a positive Abbe number, similarly increasing chromatic aberration generated by the diffractive surface Lm. Thus, the optical power of the diffractive surface Lm cannot be increased. In a case where the dispersion-controlled diffractive surface Lm is implemented by a metasurface, it is difficult to design a metastructure having high diffraction efficiency to obtain a high-dispersion characteristic corresponding to a positive Abbe number.

Inequality (1) may be replaced with inequality (1a) below:

$$- 0.1 < 1 / {v}_{0} < 0.1 \qquad ( 1 a )$$

Inequality (1) may be replaced with inequality (1b) below:

$$- 0.05 < 1 / {v}_{0} < 0.08 \qquad ( 1 b )$$

Each example properly sets the wavelength dispersion characteristic of the diffractive surface in an optical system including the dispersion-controlled diffractive surface and two reflective surfaces, and thus can reduce the number of lenses, reduce the overall optical length, and achieve an optical system with a reduced size and high optical performance.

The optical system according to each example may satisfy at least one of the following configurations and inequalities (2) to (5).

In each example, at least one of the first and second reflective surfaces M1 and M2 may be a concave mirror having positive optical power. By using reflective surfaces that do not generate chromatic aberration together with the dispersion-controlled diffractive surface Lm, this configuration can suppress chromatic aberration of the entire optical system and reduce the size of the optical system. In particular, in a case where the dispersion-controlled diffractive surface Lm is set to zero dispersion (1/ν₀=0), the optical system can be configured to generate substantially no chromatic aberration by combination with the reflective surfaces.

In each example, the following inequality (2) may be satisfied:

$$0.01 < f / \vert fm \vert < 5. \qquad ( 2 )$$

where fm is a focal length of the dispersion-controlled diffractive surface Lm, and f is a focal length of the optical system.

In a case where a plurality of diffractive surfaces Lm are provided, the focal length fm of the diffractive surface is a focal length of a diffractive surface that has the strongest optical power.

Here, the focal length fm of the dispersion-controlled diffractive surface Lm is calculated by the following equation (2):

$$\frac{1}{{f}_{m}} = - 2 {U}_{2}$$

where U₂ is a second-order coefficient of the optical path difference function of the surface at a use wavelength (design wavelength).

Equation (2) defines a proper power distribution of the dispersion-controlled diffractive surface Lm in the optical system. In a case where f/|fm| becomes higher than the upper limit of inequality (2), the focal length of the diffractive surface Lm becomes excessively short relative to the focal length of the optical system, a large monochromatic aberration such as a spherical aberration increases, and it becomes difficult to achieve high optical performance. In a case where f/|fm| becomes lower than the lower limit of inequality (2), the focal length of the diffractive surface Lm becomes excessively large relative to the focal length of the optical system, the optical overall length of the optical system increases, and it becomes difficult to reduce the size of the optical system.

Inequality (2) may be replaced with inequality (2a) below:

$$0.05 < f / \vert fm \vert < 4. \qquad ( 2 a )$$

Inequality (2) may be replaced with inequality (2b) below:

$$0.1 < f / \vert fm \vert < 3. \qquad ( 2 b )$$

In each example, the following inequality (3) may be satisfied:

$$\vert fm / fr \vert < 10. \qquad ( 3 )$$

where fm is a focal length of the dispersion-controlled diffractive surface Lm, and fr is a focal length of a reflective surface having the strongest optical power among the first and second reflective surfaces M1 and M2.

Inequality (3) defines a proper power distribution between the dispersion-controlled diffractive surface Lm and the reflective surface having the strongest optical power. In a case where |fm/fr| becomes higher than the upper limit of inequality (3), the optical power of the diffractive surface Lm becomes excessively strong relative to that of the reflective surface, a large monochromatic aberration such as a spherical aberration is generated on the diffractive surface Lm, and I becomes difficult to acquire high optical performance.

Inequality (3) may be replaced with inequality (3a):

$$\vert fm / fr \vert < 8.0 \qquad ( 3 a )$$

Inequality (3) may be replaced with inequality (3b):

$$\vert fm / fr \vert < 6.0 \qquad ( 3 b )$$

In each example, the dispersion-controlled diffractive surface Lm may be disposed on the object side of (closer to the object than) the first reflective surface M1. In this case, the following inequality (4) may be satisfied:

$$0.1 < D 1 / ( f / Fno ) < 1.1 \qquad ( 4 )$$

where D1 is an effective optical radius of the first reflective surface M1, f is a focal length of the optical system, and Fno is a full aperture ratio of the optical system.

The effective optical radius is a radius (mm) of a region of the first reflective surface M1 through which light rays contributing to imaging pass on the image plane. The full aperture ratio is an aperture ratio (F-number) when the aperture stop fully opens.

Inequality (4) defines a proper relationship between an entrance pupil diameter of the optical system and the effective optical radius of the first reflective surface M1. Disposing the dispersion-controlled diffractive surface Lm on the object side of (closer to the object than) the first reflective surface M1 to converge an incident light beam to the first reflective surface M1 can reduce the effective optical radius of the first reflective surface M1 and the size of the optical system. This configuration is particularly beneficial in a telephoto optical system having a large entrance pupil diameter and a large aperture ratio. In a case where D1/(f/Fno) is lower than the lower limit of inequality (4), the effective optical radius of the first reflective surface M1 becomes excessively small relative to the entrance pupil diameter, requiring the diffractive surface Lm to have excessively strong optical power, and increasing a monochromatic aberration such as a spherical aberration. In a case where D1/(f/Fno) becomes higher than the upper limit of inequality (4), the effective optical radius of the first reflective surface M1 becomes excessively large, and increases the size of the optical system.

Inequality (4) may be replaced with inequality (4a) below:

$$0.2 < D 1 / ( f / Fno ) < 0.8 \qquad ( 4 a )$$

Inequality (4) may be replaced with inequality (4b) below:

$$0.3 < D 1 / ( f / Fno ) < 0.7 \qquad ( 4 b )$$

In each example, the following inequality (5) may be satisfied:

$$0.1 < OAL / f < 1.4 \qquad ( 5 )$$

where OAL is an overall optical length of the optical system, and f is a focal length of the optical system.

The overall optical length OAL is a distance along an optical axis from a lens surface (foremost surface) closest to the object to the image plane. A part corresponding to a glass block such as the cover glass CG is converted into an air-equivalent length.

Inequality (5) defines a proper telephoto ratio of the optical system. In a case where OAL/f becomes lower than the lower limit of inequality (5), the overall optical length becomes excessively short relative to the focal length of the optical system. As a result, the dispersion-controlled diffractive surface Lm and each reflective surface bear strong optical power even when the optical path is folded by the first and second reflective surfaces M1 and M2. Therefore, it becomes difficult to correct a monochromatic aberration such as a spherical aberration and curvature of field. In a case where OAL/f becomes higher than the upper limit of inequality (5), the overall optical length becomes excessively long relative to the focal length, and the size of the optical system increases.

Inequality (5) may be replaced with inequality (5a) below:

$$0.2 < OAL / f < 1. \qquad ( 5 a )$$

Inequality (5) may be replaced with inequality (5b) below:

$$0.2 < OAL / f < 0.6 \qquad ( 5 b )$$

As in each example, the dispersion-controlled diffractive surface Lm may have positive optical power. In a case where a plurality of diffractive surfaces Lm are provided, at least one diffractive surface Lm may have positive optical power. By providing positive optical power, the diffractive surface Lm shares a part of the positive power of the optical system, and the size of the optical system can be reduced. In particular, by setting a diffractive surface Lm having positive optical power to low dispersion, the conventional configuration that requires two lenses (a positive lens and a negative lens) for achromatization can be replaced by a single diffractive surface Lm.

As in Examples 1 to 7, both the first and second reflective surfaces M1 and M2 may be transmissive reflective surfaces. In this case, light from an object may transmit through the second reflective surface M2, be reflected by the first reflective surface M1, be reflected by the second reflective surface M2, and transmit through the first reflective surface M1 to be guided to the image plane. Folding the optical path using two transmissive reflective surfaces in this manner can reduce the overall optical length. The polarization utilizing configuration described later can prevent unnecessary light that is not reflected by either of the two transmissive reflective surfaces from reaching the image plane.

As in Example 8, the first reflective surface M1 may have a non-reflective portion (for example, a hole portion through which light passes). In this case, light from an object may be reflected by a reflective portion of the first reflective surface M1, be reflected by the second reflective surface M2, and transmit through or pass through the non-reflective portion of the first reflective surface M1 to be guided to the image plane. Folding the optical path using two reflective surfaces in this manner can reduce the overall optical length.

As in each example, at least one refractive lens may be disposed in the optical system. By providing a refractive lens, a monochromatic aberration that cannot be fully corrected by the dispersion-controlled diffractive surface Lm and the first and second reflective surfaces M1 and M2 can be corrected, and high optical performance can be achieved. A Petzval term generated by the dispersion-controlled diffractive surface Lm is zero. Therefore, when optical power is assigned to the reflective surface to reduce the size of the optical system, the Petzval term generated by the reflective surface can be compensated by a Petzval term generated by the refractive lens, and curvature of field can be properly corrected.

As in Examples 2 to 9, the optical system may include at least one positive refractive lens and one negative refractive lens. By including positive and negative refractive lenses, a monochromatic aberration and chromatic aberration that cannot be fully corrected by the diffractive surface Lm and the first and second reflective surfaces M1 and M2 can be corrected, and high optical performance can be achieved. In a case where the optical system includes positive and negative refractive lenses, the following inequality (6) may be satisfied.

$$1 \; 000 \times \vert Σ ( Φi / vdi ) \vert / f < 1. \qquad ( 6 )$$

where Φi is optical power of an i-th refractive lens counted from the object side, νdi is an Abbe number of the i-th refractive lens based on the d-line, Σ(Φi/νdi) is a sum of Φi/νdi for all refractive lenses, and f is a focal length of the optical system.

The Abbe number νd based on the d-line is defined as:

$$v d = ( N d - 1 ) / ( NF - N C )$$

where Nd, NF, and NC are refractive indices at wavelengths of the d-line (587.6 nm), F-line (486.1 nm), and C-line (656.3 nm) in the Fraunhofer line, respectively.

Inequality (6) defines a proper achromatization state of refractive lenses included in the optical system. Since chromatic aberration is not generated by the first and second reflective surfaces M1 and M2, by setting the dispersion characteristic of the dispersion-controlled diffractive surface Lm to zero dispersion or low dispersion and properly arranging refractive lenses suitable for achromatization, chromatic aberration of the optical system can be satisfactorily corrected to achieve high optical performance. In a case where 1000×|Σ(Φi/νdi)|/f becomes higher than the upper limit of inequality (6), chromatic aberration generated by the refractive lenses becomes excessively large, and chromatic aberration is left.

Inequality (6) may be replaced with inequality (6a) below:

$$1 \; 000 \times \vert Σ ( Φi / vdi ) \vert / f < 0.8 \qquad ( 6 a )$$

Inequality (6) may be replaced with inequality (6b) below:

$$1000 ⨯ \vert \sum ( Φ i / ν di ) \vert / f < 0.4 \qquad ( 6 b )$$

### Polarization Utilizing Configuration

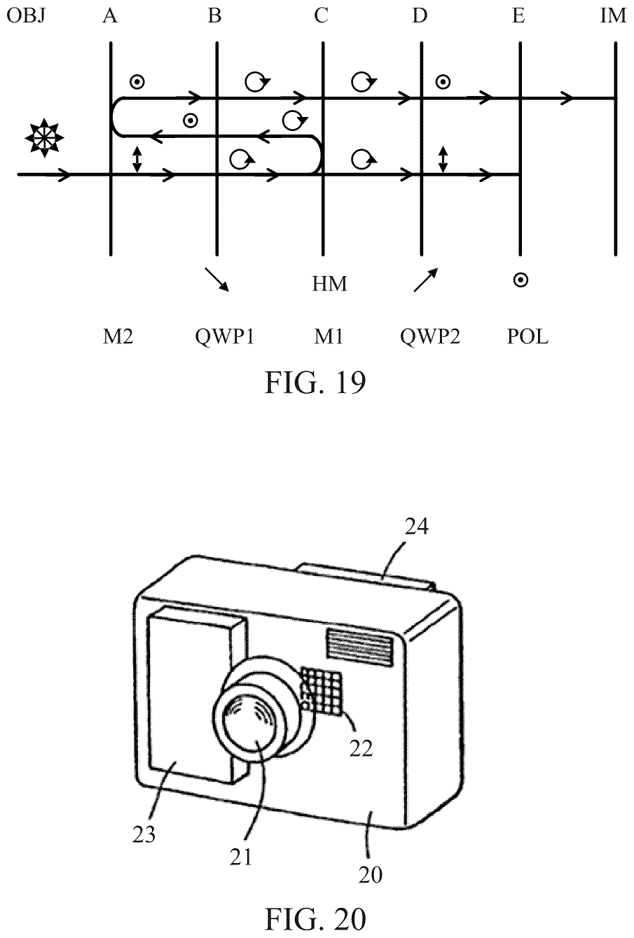

FIG. 19 illustrates an optical configuration utilizing polarization in the optical systems according to Examples 1 to 7. In these examples, both the first and second reflective surfaces M1 and M2 are transmissive reflective surfaces, and at least one of them is configured by a polarization-selective transmissive reflective element. In the configuration of FIG. 19, the first reflective surface M1 is a half-mirror (HM) C, and the second reflective surface M2 disposed on an object OBJ side of the first reflective surface M1 is a polarization-selective transmissive reflective element A. The half-mirror C is formed by a dielectric multilayer film, metal deposition, or the like, and functions as a transmissive reflective surface in a wavelength region of light to be imaged. Examples of the polarization-selective transmissive reflective element A include a wire-grid element such as WGF (registered trademark) manufactured by Asahi Kasei Corp., a reflection-type linear polarizer such as IQP-E manufactured by 3M Company, and a circularly polarized light reflective element using a cholesteric liquid crystal. In the configuration of FIG. 19, the polarization-selective transmissive reflective element A transmits linearly polarized light having a polarization direction parallel to a paper plane and reflects linearly polarized light having a polarization direction perpendicular to the paper plane.

A first quarter waveplate B is disposed between the two transmissive reflective surfaces (A and C). The first quarter waveplate B is disposed such that its slow axis is tilted by 45° relative to a polarization transmission axis of the polarization-selective transmissive reflective element A. In a case where a circularly polarized light reflective element is used as the polarization-selective transmissive reflective element A, the first quarter waveplate B may be omitted.

In the configuration of FIG. 19, a second quarter waveplate D is disposed on the image side of the half-mirror C. The second quarter waveplate D is disposed such that its slow axis is tilted by 45° relative to the polarization transmission axis of the polarization-selective transmissive reflective element A. The first quarter waveplate B and the second quarter waveplate D may be arranged such that their slow axes are tilted by 90° relative to each other. Due to such an arrangement, wavelength dispersion characteristics of the quarter waveplates cancel each other when light transmits through the first quarter waveplate B and the second quarter waveplate D.

In the configuration of FIG. 19, an absorption-type linear polarizer E is disposed on the image side of the second quarter waveplate D. In a case where orientations of the slow axes of the first and second quarter waveplates B and D are set as described above, a polarization transmission axis of the absorption-type linear polarizer E extends in a direction perpendicular to the paper plane.

Although each element described above is omitted in figures illustrating Examples 1 to 7, a method of placing each element may include cementing a film-shaped element to an optical surface of a lens, or integrally molding a wire-grid structure with a lens base material during molding of a resin lens, or another method.

The above polarization-utilizing configuration can suppress a reduction in light amount of light that follows a normal optical path from the object OBJ to the image plane IM, and reduce unnecessary light (ghost light or stray light) that reaches the image plane IM without being reflected by either of the two transmissive reflective surfaces (A and C).

An optical path of normal imaging light in the above-described polarization-utilizing configuration will be described. Imaging light incident from the object OBJ as unpolarized light transmits through the polarization-selective transmissive reflective element A and is converted into linearly polarized light having a polarization direction parallel to the paper plane. The linearly polarized light is converted into circularly polarized light by the first quarter waveplate B, and the circularly polarized light enters the half-mirror C.

A part of the circularly polarized light incident on the half-mirror C is converted by the second quarter waveplate D into linearly polarized light having a polarization direction parallel to the paper plane. This linearly polarized light is absorbed by the absorption-type linear polarizer E. On the other hand, the remaining part of the circularly polarized light incident on the half-mirror C is reflected by the half-mirror C and converted into reversely rotating circularly polarized light. The reversely rotating circularly polarized light returns to the second quarter waveplate D and is converted into linearly polarized light having a polarization direction perpendicular to the paper plane. This linearly polarized light enters the polarization-selective transmissive reflective element A and is reflected by the polarization selectivity of the polarization-selective transmissive reflective element A.

The linearly polarized light reflected by the polarization-selective transmissive reflective element A is converted by the first quarter waveplate B into circularly polarized light having a rotational direction opposite to that of the circularly polarized light initially generated by the first quarter waveplate B, and the circularly polarized light enters the half-mirror C. The circularly polarized light that has transmitted through the half-mirror C is converted by the second quarter waveplate D into linearly polarized light having a polarization direction perpendicular to the paper plane. The linearly polarized light transmits through the absorption-type linear polarizer E and reaches the image plane IM.

Thus, normal imaging light is reflected by the half-mirror C, is reflected by the polarization-selective transmissive reflective element A, and transmits through the half-mirror C to be guided to the image plane IM. In a case where a reflection-type linear polarizer is used as the polarization-selective transmissive reflective element A, an absorption-type polarizer having a polarization transmission axis in the same direction as that of the polarization transmission axis of the reflection-type linear polarizer A may be disposed on the object side of (closer to the object than) the polarization-selective transmissive reflective element A. In this configuration, a linearly polarized light component in a polarization direction perpendicular to the paper plane, among light incident from the object OBJ on the polarization-selective transmissive reflective element A, and reflected by the reflection-type linear polarizer A, can be absorbed by the absorption-type polarizer.

The optical system according to each example may further include a focusing function and an image stabilization function for correcting image blur caused by camera shake or the like, using known configurations. The focusing function is implemented, for example, by moving the whole or part of the optical system, or an image sensor in an optical axis direction. The image stabilization function is implemented, for example, by decentering movement of the whole or part of the optical system, or an image sensor relative to the optical axis. The focusing function and the image stabilization function may be implemented using an optical element whose refractive power is variable by mechanical or electrical action, such as a shape-variable lens using pressure or electrowetting, or a liquid crystal lens.

In a case where an object image formed by the optical system according to each example is photoelectrically converted (captured) by an image sensor to generate image data, various aberrations such as distortion aberration may be electronically corrected by image processing on the image data.

An optical path difference function equivalent to that of the diffractive surface Lm may be implemented by a metalens having a so-called single-layer metasurface composed of one layer, or by a metalens having a so-called multilayer metasurface composed of a plurality of layers.

### Example 1

An optical system according to Example 1 (numerical example 1) illustrated in FIG. 1 is a medium-telephoto optical system having a diagonal half angle of view of approximately 10° and an aperture ratio of approximately 2.

The optical system includes the dispersion-controlled diffractive surface Lm disposed closest to the object, and a second reflective surface M2 and a first reflective surface M1 disposed in this order toward an image side. Folding an optical path using the first and second reflective surfaces M1 and M2 reduces an overall optical length. Providing positive refractive power to the dispersion-controlled diffractive surface Lm reduces the effective optical radius of the first reflective surface M1, and configuring the second reflective surface M2 as a concave mirror having positive optical power can reduce the size of the optical system. A refractive lens having an aspherical surface is disposed in the optical system, and high optical performance is achieved by properly distributing correction of a monochromatic aberration among the aspherical surface, the diffractive surface Lm, and the first and second reflective surfaces M1 and M2.

### Example 2

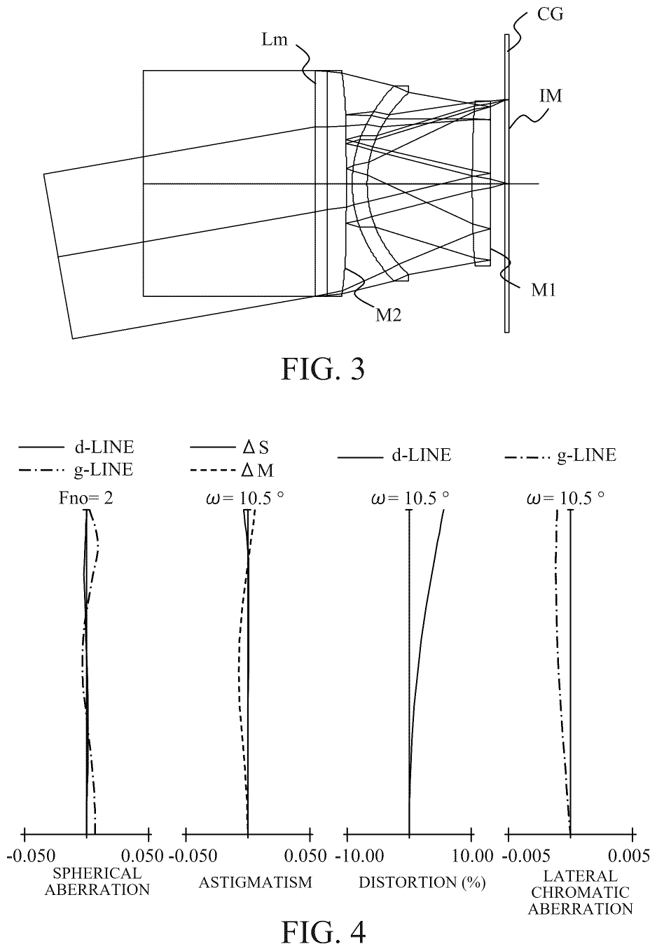

An optical system according to Example 2 (numerical example 2) illustrated in FIG. 3 has a basic configuration and optical specifications similar to those of Example 1, but differs in wavelength dispersion characteristics and optical path difference functions of the diffractive surface Lm, and shapes of the first and second reflective surfaces M1 and M2 and refractive lenses.

Example 2 achieves the achromatism of the refractive system by placing a positive refractive lens and a negative refractive lens in the optical system, and the achromatism in the entire optical system by combining a zero-dispersion diffractive surface Lm with the first and second reflective surfaces M1 and M2.

### Example 3

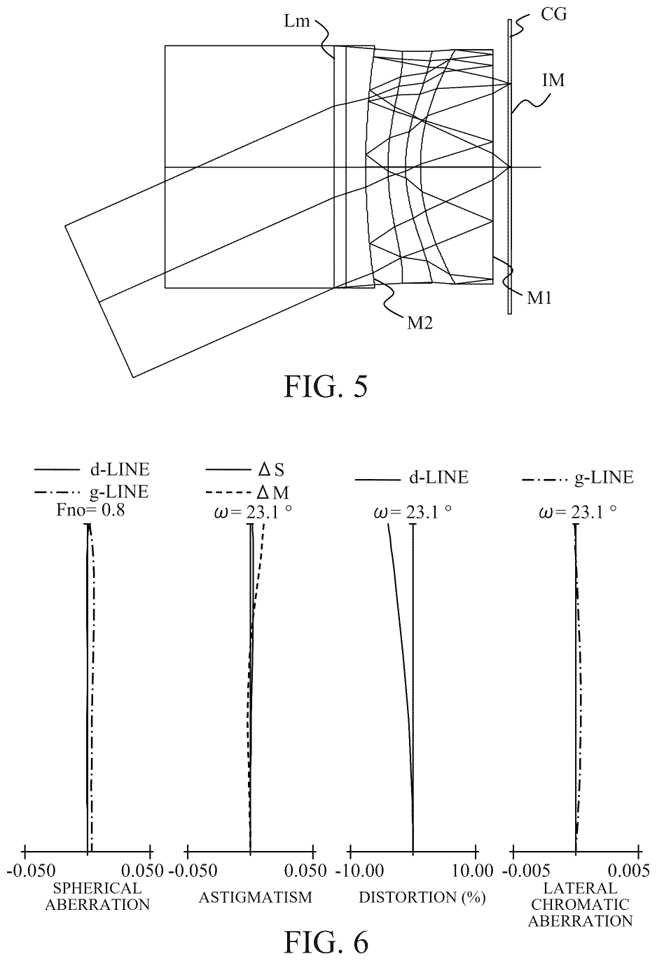

An optical system according to Example 3 (numerical example 3) illustrated in FIG. 5 is a large-aperture standard optical system having a diagonal half angle of view of approximately 23° and an aperture ratio of approximately 0.8.

The basic configuration of the optical system according to this example is similar to that of Example 2, but differs from Example 2 in optical specifications, wavelength dispersion characteristics and optical path difference functions of the diffractive surface Lm, and shapes of the first and second reflective surfaces M1 and M2 and refractive lenses.

### Example 4

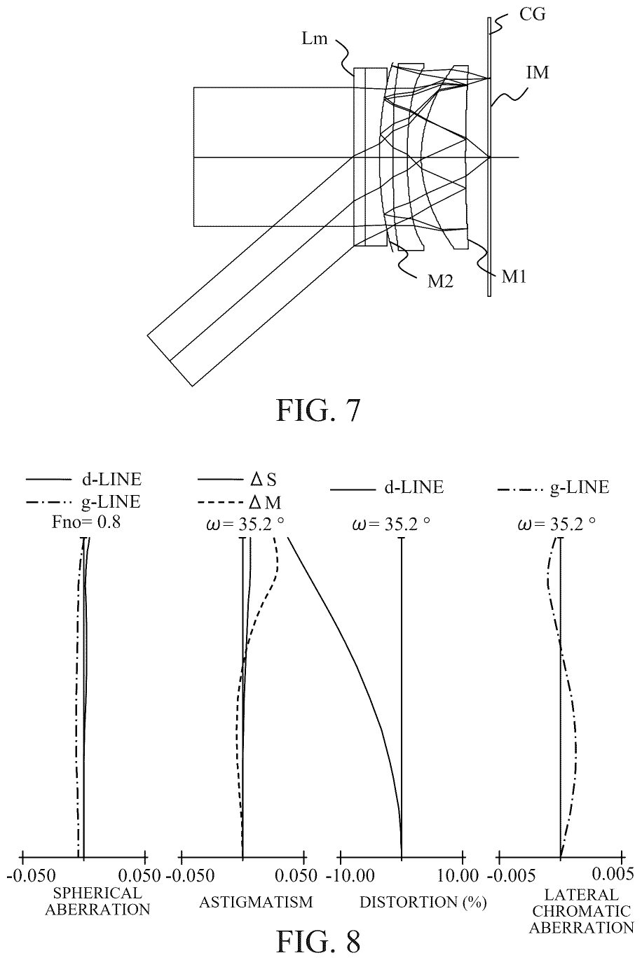

An optical system according to Example 4 (numerical example 4) illustrated in FIG. 7 is a large-aperture wide-angle optical system having a diagonal half angle of view of approximately 35° and an aperture ratio of approximately 0.8.

The basic configuration of the optical system according to this example is similar to that of Example 2, but differs from Example 2 in optical specifications, wavelength dispersion characteristics and optical path difference functions of the diffractive surface Lm, and shapes of the first and second reflective surfaces M1 and M2 and refractive lenses.

### Example 5

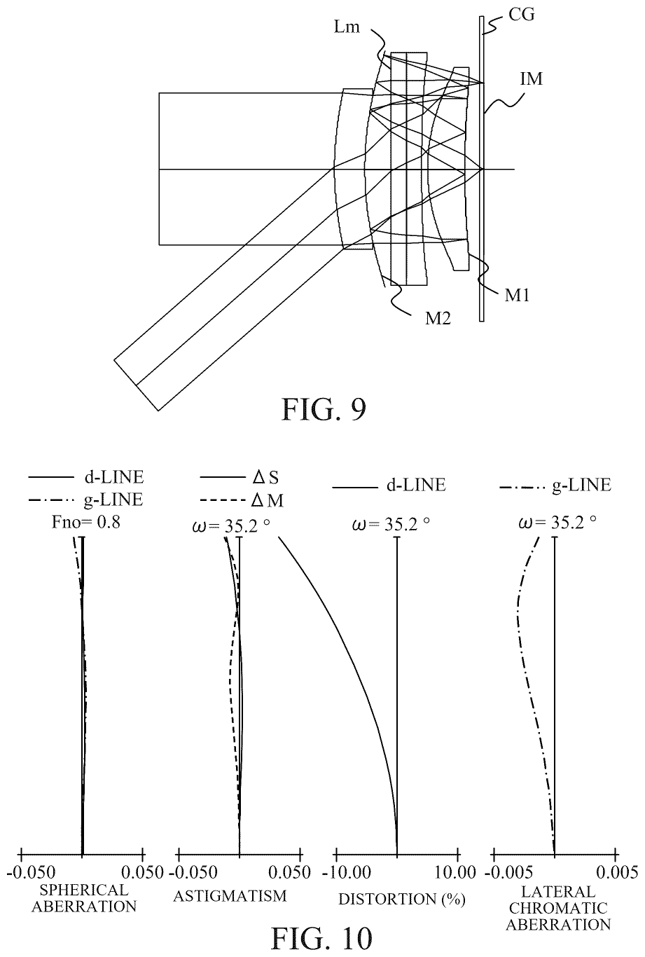

An optical system according to Example 5 (numerical example 5) illustrated in FIG. 9 has optical specifications similar to those of Example 4, but differs in that the dispersion-controlled diffractive surface Lm is disposed between the first and second reflective surfaces M1 and M2, and wavelength dispersion characteristics of the diffractive surface Lm differ from those according to Example 4.

In this example, imaging light passes through the diffractive surface Lm three times. Thus, characteristics of the diffractive surface Lm, which has a zero Petzval sum and controllable wavelength dispersion characteristics, can be more effectively utilized.

### Example 6

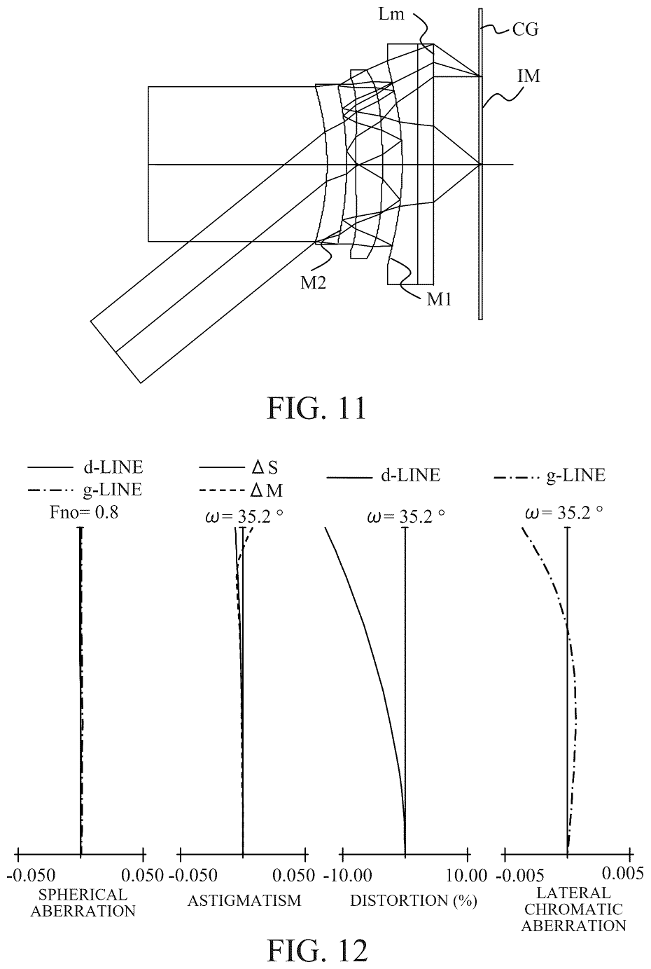

An optical system according to Example 6 (numerical example 6) illustrated in FIG. 11 has optical specifications similar to those according to Example 4, but differs in that the dispersion-controlled diffractive surface Lm is disposed on an image side of the first and second reflective surfaces M1 and M2, and wavelength dispersion characteristics of the diffractive surface Lm differ from those of Example 4.

This example places the diffractive surface Lm at a position where a height of a chief paraxial ray is high, and can selectively control lateral chromatic aberration and an exit pupil position without significantly affecting longitudinal chromatic aberration or spherical aberration.

### Example 7

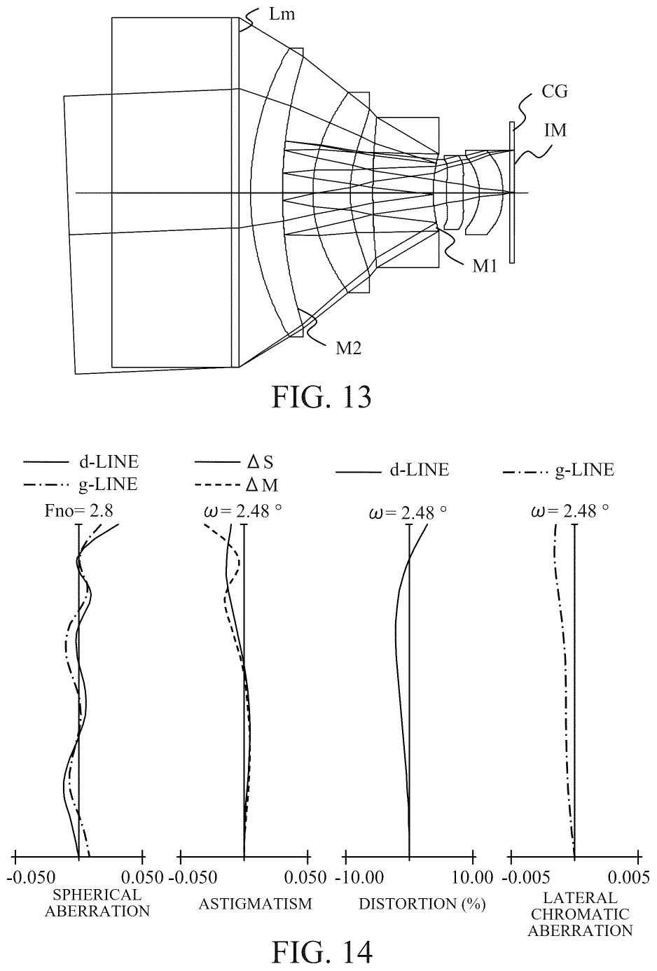

An optical system according to Example 7 (numerical example 7) illustrated in FIG. 13 is a super-telephoto optical system having a diagonal half angle of view of approximately 2.5° and an aperture ratio of approximately 2.8. A basic configuration of the optical system according to this example and wavelength dispersion characteristics of the diffractive surface Lm are similar to those of Example 2. In this example, the diffractive surface Lm is disposed on the object side of the first and second reflective surfaces M1 and M2, and optical specifications of the optical system, an optical path difference function of the diffractive surface Lm, and shapes of the first and second reflective surfaces M1 and M2 and refractive lenses differ from those of Example 2.

### Example 8

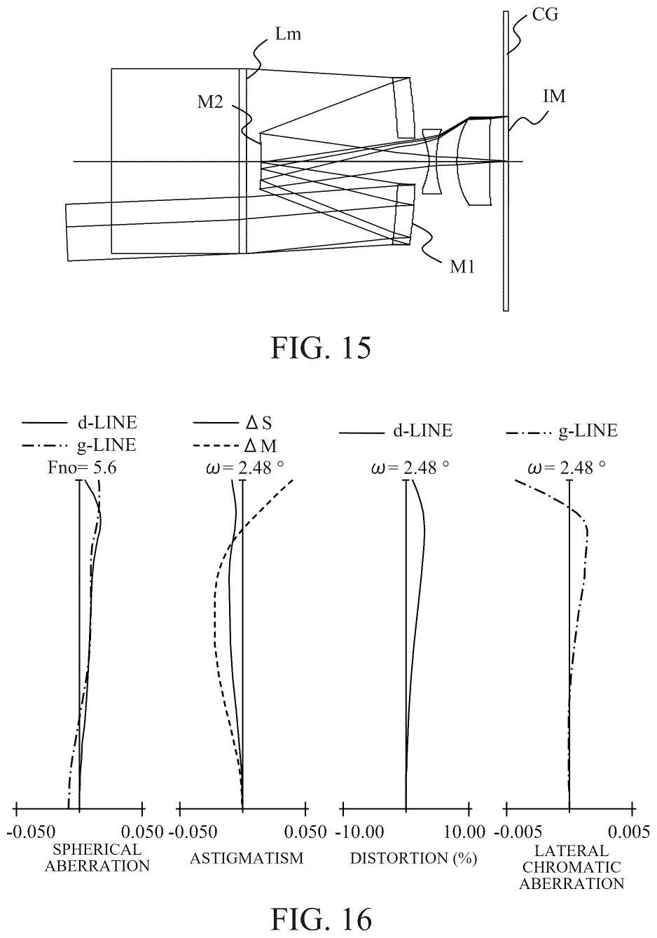

An optical system according to Example 8 (numerical example 8) illustrated in FIG. 15 is a super-telephoto optical system having a diagonal half angle of view of approximately 2.5° and an aperture ratio of approximately 5.6. A basic configuration of the optical system according to this example and wavelength dispersion characteristics of the diffractive surface Lm are similar to those of Example 7. This example uses a so-called catadioptric configuration in which an optical path is folded by a combination of the first reflective surface M1 having a non-reflective portion (hole portion) and the second reflective surface M2, thereby reducing an overall optical length.

### Example 9

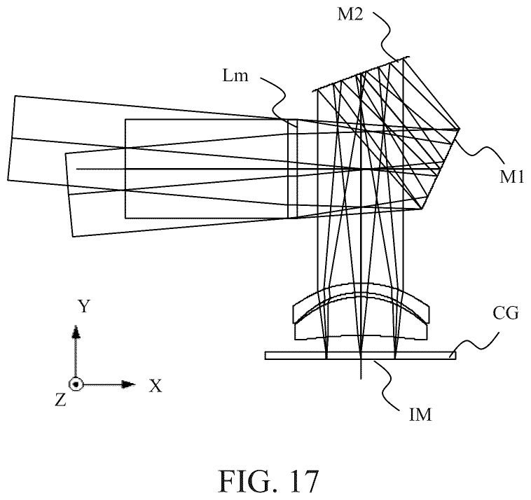

An optical system according to Example 9 illustrated in FIG. 17 is a medium-telephoto optical system having a half angle of view of approximately 7° and an aperture ratio of approximately 4.

In the optical system according to this example, the arrangement and wavelength dispersion characteristics of the diffractive surface Lm are similar to those of Example 7.

In this example, the first reflective surface M1 and the second reflective surface M2 include freeform (aspherical) surfaces, and an optical path is formed along a decentered optical axis, thereby reducing the overall volume of the optical system.

The reduction in T-number is approximately three-step in the coaxial folding configurations according to Examples 1 to 7 employing the above-described polarization utilizing configuration, and approximately one-step in the catadioptric configuration according to Example 8. In the freeform-mirror decentering configuration according to Example 9, no reduction in T-number occurs.

Although the coaxial folding configuration utilizing polarization results in a relatively large T-number reduction, it enables a folded optical path configuration that reduces the overall optical length over a wide range from a wide-angle end to a medium-telephoto end, and is beneficial in achieving a large aperture particularly in the wide-angle end to the medium-telephoto range. In the catadioptric configuration, issues such as a ring-shaped blur caused by pupil light-shielding and shielding of imaging light in wide-angle to standard optical systems may arise; however, a favorable balance can be achieved between the reduced overall optical length and T-number reduction in the medium-telephoto optical system. The freeform-mirror decentering configuration is beneficial in suppressing the T-number reduction, but the reflective surfaces are difficult to manufacture, and the effect of reducing the overall optical length is inferior to that of the coaxial folding configuration.

Considering these factors and selecting one of the above three optical configurations according to the required optical specifications can provide an optical system having reduced size and high optical performance.

Numerical examples 1 to 9 will be illustrated below. In each numerical example, surface number i indicates the order of a surface counted from the object side. r denotes a radius of curvature (mm) of an i-th surface from the object side, and d denotes an on-axis lens thickness or air gap (mm) between i-th and (i+1)-th surfaces. nd denotes a refractive index of an optical material between i-th and (i+1)-th surfaces for the d-line. νd denotes an Abbe number of an optical material between i-th and (i+1)-th surfaces based on the d-line, as defined above. The effective diameter (mm) corresponds to the above optical effective diameter and indicates the radius (mm) of a region through which light rays contributing to imaging pass on the i-th surface.

BF denotes the back focus (mm). The back focus is defined as a distance expressed as an air-equivalent length on the optical axis from a surface closest to the image plane (final surface) of the optical system to the paraxial image plane. The overall lens length corresponds to the above overall optical length, and is defined as a length obtained by adding the back focus to the distance along the optical axis from the foremost surface of the optical system to the final surface of the optical system.

An asterisk attached to the surface number indicates that the surface has an aspherical shape. The aspherical surface shape is expressed by the following equation:

$$x = ( {h}^{2} / R ) / [ 1 + {\{ 1 - ( 1 + k ) {( h / R )}^{2} \}}^{1 / 2} ] + A 4 \cdot {h}^{4} + A 6 \cdot {h}^{6} + A 8 \cdot {h}^{8} + A 10 \cdot {h}^{10}$$

where x is a displacement amount from a surface vertex in the optical axis direction, h is a height from the optical axis in a direction orthogonal to the optical axis, a light traveling direction is positive, R is a paraxial radius of curvature, k is a conic constant, and A4 to A10 are aspherical coefficients. “e+M” for the conic constant and aspherical coefficients means×10^{±M}.

The optical path difference function of a surface at the design wavelength is expressed by the following equation:

$$ψ0 = U 2 \cdot {h}^{2} + U 4 \cdot {h}^{4} + U 6 \cdot {h}^{6} + U 8 \cdot {h}^{8} + U 10 \cdot {h}^{10}$$

where U2 to U10 are coefficients of the optical path difference function of the surface.

“(diffraction)” attached to a surface number indicates an optical design surface using an optical path difference function.

Table 1 summarizes values of inequalities (1) to (6) for numerical examples 1 to 9. As understood from Table 1, the optical systems according to numerical examples 1 to 8 satisfy inequalities (1) to (6). The optical system according to numerical example 9 satisfies inequalities (1), (2), and (6).

FIGS. 2, 4, 6, 8, 10, 12, 14, and 16 respectively illustrate longitudinal aberration diagrams (spherical aberration, astigmatism, distortion, and lateral chromatic aberration) of the optical systems according to numerical examples 1 to 8 corresponding to Examples 1 to 8 in an in-focus state on an object at infinity (referred to as an in-focus state at infinity hereinafter). In the spherical aberration diagrams, the vertical axis Fno indicates the F-number, and in the astigmatism, distortion, and chromatic aberration diagrams, the vertical axis ω indicates a half angle of field (°). The horizontal axis represents each aberration amount.

In the spherical aberration diagrams, a solid line represents a spherical aberration amount for the d-line (wavelength 587.6 nm), and an alternate long and two short dashes line represents a spherical aberration amount for the g-line (wavelength 435.8 nm). In the astigmatism diagrams, a solid line S represents an astigmatism amount on a sagittal image plane, and a dashed line M represents an astigmatism amount on a meridional image plane. The distortion diagrams represent a distortion amount for the d-line. The lateral chromatic aberration diagrams represent a lateral chromatic aberration amount for the g-line.

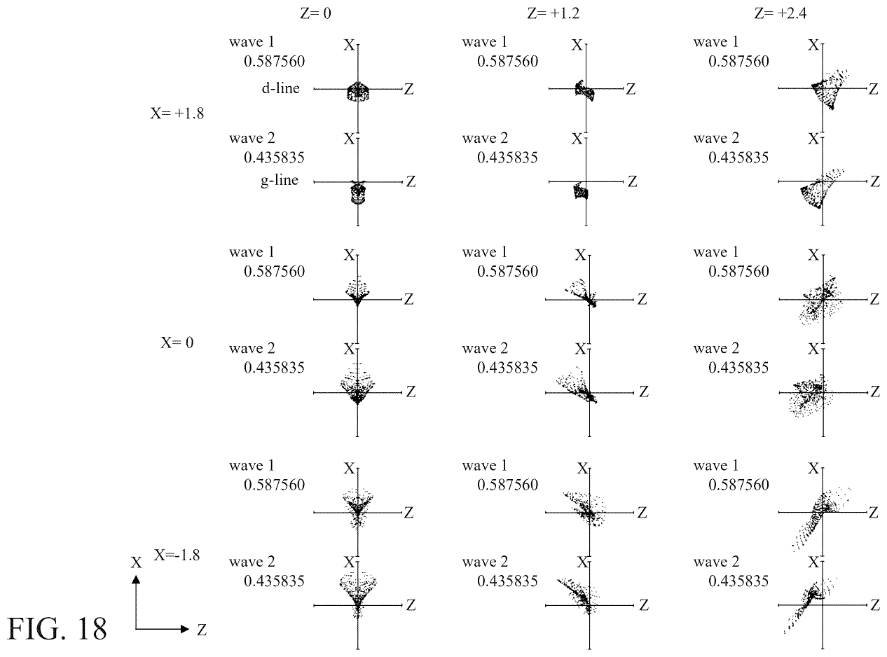

FIG. 18 is a spot diagram for the d-line and g-line in the in-focus state at infinity of the optical system according to numerical example 9 corresponding to Example 9.

NUMERICAL EXAMPLE 1
UNIT: mm
SURFACE DATA

| Surface No. | r | d | nd | νd | Effective Diameter |
|---|---|---|---|---|---|
| 1 (diffraction) | ∞ | 0.40 | 1.45867 | 67.9 | 7.60 |
| 2 | ∞ | 0.50 | 1.49171 | 57.4 | 7.35 |
| 3* | 18.177 | 0.50 | | | 6.94 |
| 4* | 4.626 | 0.50 | 1.64220 | 22.4 | 5.94 |
| 5* | 4.200 | 2.72 | | | 5.54 |
| 6* | 15.045 | 0.50 | 1.49171 | 57.4 | 3.73 |
| 7* | 11.523 | −0.50 | | | 3.41 |
| 8* | 15.045 | −2.72 | | | 3.37 |
| 9* | 4.200 | −0.50 | 1.64220 | 22.4 | 4.38 |
| 10* | 4.626 | −0.50 | | | 4.67 |
| 11* | 18.177 | 0.50 | | | 5.08 |
| 12* | 4.626 | 0.50 | 1.64220 | 22.4 | 5.21 |
| 13* | 4.200 | 2.72 | | | 5.10 |
| 14* | 15.045 | 0.50 | 1.49171 | 57.4 | 5.50 |
| 15* | 11.523 | 0.77 | | | 5.52 |
| 16 | ∞ | 0.11 | 1.51633 | 64.1 | 10.00 |
| 17 | ∞ | 0.00 | | | 10.00 |
| Image Plane | ∞ | | | | |

ASPHERIC DATA
1st Surface (Diffractive surface)
Designed Wavelength: 0.58756 [μm]
U2 = −7.04145e−02 U4 = 4.29237e−04 U6 = 2.36760e−06 U8 = −1.38378e−07 U10 =
8.49695e−09

OPTICAL PATH DIFFERENCE DISPERSION OF SURFACE
1/ν₀ = 0.0033
P(λ) = −8.15777e+00 · λ³ +1.73588e+01 · λ² −1.36506e+01 · λ +4.68253e+00
P(λ_{d}) = 1.000000e+00
P(λ_{C}) = 8.945633e−01
P(λ_{F}) = 1.211667e+00

3rd Surface
K = 0.00000e+00 A4 = −7.31335e−04 A6 = −2.07839e−05
4th Surface
K = 0.00000e+00 A4 = −2.69396e−03 A6 = −1.27809e−04 A8 −4.88912e−06 A10 =
2.01970e−07
5th Surface
K = 0.00000e+00 A4 = −3.52870e−03 A6 = −1.91524e−04 A8 = −1.80392e−07
6th Surface
K = 0.00000e+00 A4 = 3.03962e−04 A6 = 6.15251e−05 A8 = −1.70049e−05
7th Surface
K = 0.00000e+00 A4 = −9.61651e−04 A6 = 4.43089e−05 A8 = −1.16768e−05 A10 =
3.28426e−07
8th Surface
K = 0.00000e+00 A4 = 3.03962e−04 A6 = 6.15251e−05 A8 = −1.70049e−05
9th Surface
K = 0.00000e+00 A4 = −3.52870e−03 A6 = −1.91524e−04 A8 = −1.80392e−07
10th Surface
K = 0.00000e+00 A4 = −2.69396e−03 A6 = −1.27809e−04 A8 = −4.88912e−06 A10 =
2.01970e−07
11th Surface
K = 0.00000e+00 A4 = −7.31335e−04 A6 = −2.07839e−05
12th Surface
K = 0.00000e+00 A4 = −2.69396e−03 A6 = −1.27809e−04 A8 = −4.88912e−06 A10 =
2.01970e−07
13th Surface
K = 0.00000e+00 A4 = −3.52870e−03 A6 = −1.91524e−04 A8 = −1.80392e−07
14th Surface
K = 0.00000e+00 A4 = 3.03962e−04 A6 = 6.15251e−05 A8 = −1.70049e−05
15th Surface
K = 0.00000e+00 A4 = −9.61651e−04 A6 = 4.43089e−05 A8 = −1.16768e−05 A10 =
3.28426e−07

VARIOUS DATA

| | |
|---|---|
| Focal Length | 15.20 |
| Fno | 2.00 |
| Half Angle of View (°) | 10.51 |
| Image Height | 2.82 |
| Overall Lens Length | 5.96 (in Air) |
| BF | 0.84 (in Air) |
| Entrance Pupil Position | 0.00 |
| Exit Pupil Position | −18.44 |
| Front Principal-Point Position | 2.67 |
| Rear Principal-Point Position | −15.20 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 15.20 | 6.00 | 2.67 | −15.20 |

SINGLE LENS DATA

| Lens | Starting Surface | Focal Length |
|---|---|---|
| 1 | 1 | 7.10 |
| 2 | 2 | −36.97 |
| 3 | 4 | −131.41 |
| 4 | 6 | −105.05 |
| CG | 16 | 0.00 |

NUMERICAL EXAMPLE 2
UNIT: mm
SURFACE DATA

| Surface No. | r | d | nd | νd | Effective Diameter |
|---|---|---|---|---|---|
| 1 (diffraction) | ∞ | 0.40 | 1.45867 | 67.9 | 7.60 |
| 2 | ∞ | 0.65 | 1.49171 | 57.4 | 7.52 |
| 3* | −873.868 | 0.20 | | | 7.42 |
| 4* | 4.350 | 0.50 | 1.68100 | 18.2 | 6.58 |
| 5* | 3.939 | 3.54 | | | 6.11 |
| 6* | 53.819 | 0.61 | 1.49171 | 57.4 | 5.34 |
| 7* | 16101.975 | −0.61 | | | 5.18 |
| 8* | 53.819 | −3.54 | | | 5.00 |
| 9* | 3.939 | −0.50 | 1.68100 | 18.2 | 4.33 |
| 10* | 4.350 | −0.20 | | | 4.57 |
| 11* | −873.868 | 0.20 | | | 4.62 |
| 12* | 4.350 | 0.50 | 1.68100 | 18.2 | 4.81 |
| 13* | 3.939 | 3.54 | | | 4.61 |
| 14* | 53.819 | 0.61 | 1.49171 | 57.4 | 5.48 |
| 15* | 16101.975 | 0.50 | | | 5.54 |
| 16 | ∞ | 0.11 | 1.51633 | 64.1 | 10.00 |
| 17 | ∞ | 0.00 | | | 10.00 |
| Image Plane | ∞ | | | | |

ASPHERIC DATA
1st Surface (Diffractive surface)
Designed Wavelength: 0.58756 [μm]
U2 = −3.20489e−02 U4 = 3.80728e−04 U6 = −3.85874e−06 U8 = 3.60971e−07
U10 = −1.62009e−09
OPTICAL PATH DIFFERENCE DISPERSION OF SURFACE
1/ν₀ = 0
P(λ) = 0.58756/λ
P(λ_{d}) = 1.000000e+00
P(λ_{C}) = 8.953022e−01
P(λ_{F}) = 1.208648e+00

3rd Surface
K = 0.00000e+00 A4 = −5.98573e−04 A6 = −9.59531e−06
4th Surface
K = 0.00000e+00 A4 = 5.60733e−05 A6 = −1.76965e−05 A8 = −6.21435e−06 A10 =
1.32369e−09
5th Surface
K = 0.00000e+00 A4 = 1.04101e−04 A6 = 2.53936e−06 A8 = −9.38371e−06
6th Surface
K = 0.00000e+00 A4 = 4.53344e−04 A6 = −1.03391e−04 A8 = 1.43491e−05
7th Surface
K = 0.00000e+00 A4 = −1.51804e−04 A6 = −3.85332e−05 A8 = 4.52831e−06
A10 = −1.33895e−08
8th Surface
K = 0.00000e+00 A4 = 4.53344e−04 A6 = −1.03391e−04 A8 = 1.43491e−05
9th Surface
K = 0.00000e+00 A4 = 1.04101e−04 A6 = 2.53936e−06 A8 = −9.38371e−06
10th Surface
K = 0.00000e+00 A4 = 5.60733e−05 A6 = −1.76965e−05 A8 = −6.21435e−06 A10 =
1.32369e−09
11th Surface
K = 0.00000e+00 A4 = −5.98573e−04 A6 = −9.59531e−06
12th Surface
K = 0.00000e+00 A4 = 5.60733e−05 A6 = −1.76965e−05 A8 = −6.21435e−06 A10 =
1.32369e−09
13th Surface
K = 0.00000e+00 A4 = 1.04101e−04 A6 = 2.53936e−06 A8 = −9.38371e−06
14th Surface
K = 0.00000e+00 A4 = 4.53344e−04 A6 = −1.03391e−04 A8 = 1.43491e−05
15th Surface
K = 0.00000e+00 A4 = −1.51804e−04 A6 = −3.85332e−05 A8 = 4.52831e−06
A10 = −1.33895e−08

VARIOUS DATA

| | |
|---|---|
| Focal Length | 15.20 |
| Fno | 2.00 |
| Half Angle of View (°) | 10.51 |
| Image Height | 2.82 |
| Overall Lens Length | 6.46 (in Air) |
| BF | 0.57 (in Air) |
| Entrance Pupil Position | 0.00 |
| Exit Pupil Position | −14.83 |
| Front Principal-Point Position | −0.38 |
| Rear Principal-Point Position | −15.20 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 15.20 | 6.50 | −0.38 | −15.20 |

SINGLE LENS DATA

| Lens | Starting Surface | Focal Length |
|---|---|---|
| 1 | 1 | 15.60 |
| 2 | 2 | 1777.20 |
| 3 | 4 | −120.59 |
| 4 | 6 | 109.82 |
| CG | 16 | 0.00 |

NUMERICAL EXAMPLE 3
UNIT: mm
SURFACE DATA

| Surface No. | r | d | nd | νd | Effective Diameter |
|---|---|---|---|---|---|
| 1 (diffraction) | ∞ | 0.40 | 1.45867 | 67.9 | 8.25 |
| 2 | ∞ | 0.67 | 1.49171 | 57.4 | 8.17 |
| 3* | 25.682 | 0.76 | | | 8.00 |
| 4* | 8.141 | 0.60 | 1.64220 | 22.4 | 7.88 |
| 5* | 5.422 | 0.50 | | | 7.87 |
| 6* | 6.270 | 2.47 | 1.49171 | 57.4 | 7.98 |
| 7 | ∞ | −2.47 | | | 7.66 |
| 8* | 6.270 | −0.50 | | | 7.30 |
| 9* | 5.422 | −0.60 | 1.64220 | 22.4 | 7.24 |
| 10* | 8.141 | −0.76 | | | 7.35 |
| 11* | 25.682 | 0.76 | | | 7.49 |
| 12* | 8.141 | 0.60 | 1.64220 | 22.4 | 7.08 |
| 13* | 5.422 | 0.50 | | | 6.80 |
| 14* | 6.270 | 2.47 | 1.49171 | 57.4 | 6.70 |
| 15 | ∞ | 0.50 | | | 6.02 |
| 16 | ∞ | 0.11 | 1.51633 | 64.1 | 10.00 |
| 17 | ∞ | 0.00 | | | 10.00 |
| Image Plane | ∞ | | | | |

ASPHERIC DATA
1st Surface (Diffractive surface)
Designed Wavelength: 0.58756 [μm]
U2 = −2.14859e−02 U4 = 3.05969e−04 U6 = −8.39039e−06 U8 = 1.40702e−07
U10 = −2.28891e−09
OPTICAL PATH DIFFERENCE DISPERSION OF SURFACE
1/ν₀ = 0.0250
P(λ) = −1.08847e+01 · λ³ +2.26307e+01 · λ² −1.71261e+01 · λ +5.45778e+00
P(λ_{d}) = 1.000000e+00
P(λ_{C}) = 8.886774e−01
P(λ_{F}) = 1.229922e+00
3rd Surface
K = 0.00000e+00 A4 = −1.78071e−04 A6 = 7.05292e−06
4th Surface
K = 0.00000e+00 A4 = −1.73243e−03 A6 = −1.06953e−05 A8 = −8.24978e−07
A10 = −2.01336e−08
5th Surface
K = 0.00000e+00 A4 = −2.75919e−03 A6 = −1.90134e−05 A8 = −1.23270e−06
6th Surface
K = 0.00000e+00 A4 = −6.32397e−04 A6 = −2.33184e−05 A8 = 5.75123e−08
8th Surface
K = 0.00000e+00 A4 = −6.32397e−04 A6 = −2.33184e−05 A8 = 5.75123e−08
9th Surface
K = 0.00000e+00 A4 = −2.75919e−03 A6 = −1.90134e−05 A8 = −1.23270e−06
10th Surface
K = 0.00000e+00 A4 = −1.73243e−03 A6 = −1.06953e−05 A8 = −8.24978e−07
A10 = −2.01336e−08
11th Surface
K = 0.00000e+00 A4 = −1.78071e−04 A6 = 7.05292e−06
12th Surface
K = 0.00000e+00 A4 = −1.73243e−03 A6 = −1.06953e−05 A8 = −8.24978e−07
A10 = −2.01336e−08
13th Surface
K = 0.00000e+00 A4 = −2.75919e−03 A6 = −1.90134e−05 A8 = −1.23270e−06
14th Surface
K = 0.00000e+00 A4 = −6.32397e−04 A6 = −2.33184e−05 A8 = 5.75123e−08

VARIOUS DATA

| | |
|---|---|
| Focal Length | 6.60 |
| Fno | 0.80 |
| Half Angle of View (°) | 23.14 |
| Image Height | 2.82 |
| Overall Lens Length | 5.96 (in Air) |
| BF | 0.57 (in Air) |
| Entrance Pupil Position | 0.00 |
| Exit Pupil Position | 59.62 |
| Front Principal-Point Position | 7.33 |
| Rear Principal-Point Position | −6.60 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 6.60 | 6.00 | 7.33 | −6.60 |

SINGLE LENS DATA

| Lens | Starting Surface | Focal Length |
|---|---|---|
| 1 | 1 | 23.27 |
| 2 | 2 | −52.23 |
| 3 | 4 | −27.64 |
| 4 | 6 | 12.75 |
| CG | 16 | 0.00 |

NUMERICAL EXAMPLE 4
UNIT: mm
SURFACE DATA

| Surface No. | r | d | nd | νd | Effective Diameter |
|---|---|---|---|---|---|
| 1 (diffraction) | ∞ | 0.40 | 1.45867 | 67.9 | 6.42 |
| 2 | ∞ | 0.51 | 1.64220 | 22.4 | 5.97 |
| 3* | 12.670 | 0.50 | | | 5.23 |
| 4* | 124.437 | 0.50 | 1.64220 | 22.4 | 4.95 |
| 5* | 11.977 | 0.50 | | | 4.95 |
| 6* | 4.215 | 1.60 | 1.54390 | 56.0 | 5.34 |
| 7* | 53.899 | −1.60 | | | 5.18 |
| 8* | 4.215 | −0.50 | | | 5.75 |
| 9* | 11.977 | −0.50 | 1.64220 | 22.4 | 6.12 |
| 10* | 124.437 | −0.50 | | | 6.60 |
| 11* | 12.670 | 0.50 | | | 6.80 |
| 12* | 124.437 | 0.50 | 1.64220 | 22.4 | 6.71 |
| 13* | 11.977 | 0.50 | | | 6.41 |
| 14* | 4.215 | 1.60 | 1.54390 | 56.0 | 6.59 |
| 15* | 53.899 | 0.79 | | | 6.36 |
| 16 | ∞ | 0.11 | 1.51633 | 64.1 | 10.00 |
| 17 | ∞ | 0.00 | | | 10.00 |
| Image Plane | ∞ | | | | |

ASPHERIC DATA
1st Surface (Diffractive surface)
Designed Wavelength: 0.58756 [μm]
U 2 = −2.21744e−02 U4 = 9.45811e−04 U6 = −2.95602e−05 U8 = 1.27738e−06
U10 = −2.90765e−08
OPTICAL PATH DIFFERENCE DISPERSION OF SURFACE
1/ν₀ = 0.0667
P(λ) = −2.26691e+01 · λ³ +4.43986e+01 · λ² −3.06505e+01 · λ +8.27965e+00
P(λ_{d}) = 1.000000e+00
P(λ_{C}) = 8.792962e−01
P(λ_{F}) = 1.267609e+00
3rd Surface
K = 0.00000e+00 A4 = −2.07649e−04 A6 = 2.92887e−05
4th Surface
K = 0.00000e+00 A4 = 1.17727e−03 A6 = −4.71275e−05 A8 = 1.82894e−05
A10 = −1.28976e−06
5th Surface
K = 0.00000e+00 A4 = −2.62526e−03 A6 = 4.91910e−04 A8 = −9.16917e−06
6th Surface
K = 0.00000e+00 A4 = −4.66606e−03 A6 = 2.97579e−04 A8 = −1.64321e−05
7th Surface
K = 0.00000e+00 A4 = 2.78015e−04 A6 = −6.43271e−05 A8 = 5.59188e−06
A10 = −2.21629e−07
8th Surface
K = 0.00000e+00 A4 = −4.66606e−03 A6 = 2.97579e−04 A8 = −1.64321e−05
9th Surface
K = 0.00000e+00 A4 = −2.62526e−03 A6 = 4.91910e−04 A8 = −9.16917e−06
10th Surface
K = 0.00000e+00 A4 = 1.17727e−03 A6 = −4.71275e−05 A8 = 1.82894e−05
A10 = −1.28976e−06
11th Surface
K = 0.00000e+00 A4 = −2.07649e−04 A6 = 2.92887e−05
12th Surface
K = 0.00000e+00 A4 = 1.17727e−03 A6 = −4.71275e−05 A8 = 1.82894e−05
A10 = −1.28976e−06
13th Surface
K = 0.00000e+00 A4 = −2.62526e−03 A6 = 4.91910e−04 A8 = −9.16917e−06
14th Surface
K = 0.00000e+00 A4 = −4.66606e−03 A6 = 2.97579e−04 A8 = −1.64321e−05
15th Surface
K = 0.00000e+00 A4 = 2.78015e−04 A6 = −6.43271e−05 A8 = 5.59188e−06
A10 = −2.21629e−07

VARIOUS DATA

| | |
|---|---|
| Focal Length | 4.00 |
| Fno | 0.80 |
| Half Angle of View (°) | 35.18 |
| Image Height | 2.82 |
| Overall Lens Length | 4.87 (in Air) |
| BF | 0.87 (in Air) |
| Entrance Pupil Position | 0.00 |
| Exit Pupil Position | 10.49 |
| Front Principal-Point Position | 5.53 |
| Rear Principal-Point Position | −4.00 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 4.00 | 4.91 | 5.53 | −4.00 |

SINGLE LENS DATA

| Lens | Starting Surface | Focal Length |
|---|---|---|
| 1 | 1 | 22.55 |
| 2 | 2 | −19.73 |
| 3 | 4 | −20.67 |
| 4 | 6 | 8.31 |
| CG | 16 | 0.00 |

NUMERICAL EXAMPLE 5
UNIT: mm
SURFACE DATA

| Surface No. | r | d | nd | νd | Effective Diameter |
|---|---|---|---|---|---|
| 1* | 10.403 | 1.00 | 1.64220 | 22.4 | 5.26 |
| 2* | 10.904 | 0.86 | | | 4.86 |
| 3 (diffraction) | ∞ | 0.50 | 1.45867 | 67.9 | 4.89 |
| 4 | ∞ | 0.50 | 1.64220 | 22.4 | 4.86 |
| 5* | 36.372 | 0.20 | | | 4.83 |
| 6* | 5.855 | 1.22 | 1.49171 | 57.4 | 4.83 |
| 7* | 31.031 | −1.22 | | | 5.36 |
| 8* | 5.855 | −0.20 | | | 5.98 |
| 9* | 36.372 | −0.50 | 1.64220 | 22.4 | 6.71 |
| 10 | ∞ | −0.50 | 1.45867 | 67.9 | 7.13 |
| 11 (diffraction) | ∞ | −0.86 | | | 7.51 |
| 12* | 10.904 | 0.86 | | | 7.73 |
| 13 (diffraction) | ∞ | 0.50 | 1.45867 | 67.9 | 7.62 |
| 14 | ∞ | 0.50 | 1.64220 | 22.4 | 7.38 |
| 15* | 36.372 | 0.20 | | | 7.11 |
| 16* | 5.855 | 1.22 | 1.49171 | 57.4 | 6.65 |
| 17* | 31.031 | 0.50 | | | 6.31 |
| 18 | ∞ | 0.11 | 1.51633 | 64.1 | 10.00 |
| 19 | ∞ | 0.00 | | | 10.00 |
| Image Plane | ∞ | | | | |

ASPHERIC DATA
1st Surface
K = 0.00000e+00 A4 = −7.52738e−04 A6 = −4.03305e−05 A8 = 5.55786e−07
2nd Surface
K = 0.00000e+00 A4 = −7.93443e−05 A6 = −9.43615e−06
3rd/11th/12th Surfaces (Diffractive Surface)
Designed Wavelength: 0.58756 [μm]
U 2 = −1.18555e−02 U4 = 1.11307e−04 U6 = −2.55520e−05 U8 = −1.43329e−06
U10 = 1.29144e−07

OPTICAL PATH DIFFERENCE DISPERSION OF SURFACE
1/ν₀ = −0.0104
P(λ) = −6.91918e+00 · λ³ +1.51415e+01 · λ² −1.22523e+01 · λ +4.37524e+00
P(λ_{d}) = 1.000000e+00
P(λ_{C}) = 8.999832e−01
P(λ_{F}) = 1.202378e+00
5th Surface
K = 0.00000e+00 A4 = −1.67159e−03 A6 = 2.58566e−04 A8 = −1.01678e−05
6th Surface
K = 0.00000e+00 A4 = −1.49376e−03 A6 = 2.45797e−04 A8 = −2.13874e−05
7th Surface
K = 0.00000e+00 A4 = 3.36050e−04 A6 = −4.64461e−05 A8 = 2.42199e−06
A10 = −3.04106e−07
8th Surface
K = 0.00000e+00 A4 = −1.49376e−03 A6 = 2.45797e−04 A8 = −2.13874e−05
9th Surface
K = 0.00000e+00 A4 = −1.67159e−03 A6 = 2.58566e−04 A8 = −1.01678e−05
12th Surface
K = 0.00000e+00 A4 = −7.93443e−05 A6 = −9.43615e−06
15th Surface
K = 0.00000e+00 A4 = −1.67159e−03 A6 = 2.58566e−04 A8 = −1.01678e−05
16th Surface
K = 0.00000e+00 A4 = −1.49376e−03 A6 = 2.45797e−04 A8 = −2.13874e−05
17th Surface
K = 0.00000e+00 A4 = 3.36050e−04 A6 = −4.64461e−05 A8 = 2.42199e−06
A10 = −3.04106e−07

VARIOUS DATA

| | |
|---|---|
| Focal Length | 4.00 |
| Fno | 0.80 |
| Half Angle of View (°) | 35.18 |
| Image Height | 2.82 |
| Overall Lens Length | 4.86 (in Air) |
| BF | 0.57 (in Air) |
| Entrance Pupil Position | 0.00 |
| Exit Pupil Position | 6.69 |
| Front Principal-Point Position | 6.39 |
| Rear Principal-Point Position | −4.00 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 4.00 | 4.89 | 6.39 | −4.00 |

SINGLE LENS DATA

| Lens | Starting Surface | Focal Length |
|---|---|---|
| 1 | 1 | 197.99 |
| 2 | 3 | 42.17 |
| 3 | 4 | −56.64 |
| 4 | 6 | 14.44 |
| CG | 18 | 0.00 |

NUMERICAL EXAMPLE 6
UNIT: mm
SURFACE DATA

| Surface No. | r | d | nd | νd | Effective Diameter |
|---|---|---|---|---|---|
| 1* | −8.037 | 0.63 | 1.54390 | 56.0 | 5.00 |
| 2* | −10.909 | 0.30 | | | 5.14 |
| 3* | 54.622 | 0.85 | 1.49171 | 57.4 | 5.18 |
| 4* | −20.791 | 0.64 | | | 5.32 |
| 5* | −9.996 | −0.64 | | | 5.28 |
| 6* | −20.791 | −0.85 | 1.49171 | 57.4 | 4.93 |
| 7* | 54.622 | −0.30 | | | 4.94 |
| 8* | −10.909 | 0.30 | | | 5.05 |
| 9* | 54.622 | 0.85 | 1.49171 | 57.4 | 5.55 |
| 10* | −20.791 | 0.64 | | | 6.07 |
| 11* | −9.996 | 0.50 | 1.63550 | 23.9 | 6.65 |
| 12 | ∞ | 0.50 | 1.45867 | 67.9 | 7.36 |
| 13 (diffraction) | ∞ | 1.46 | | | 7.77 |
| 14 | ∞ | 0.11 | 1.51633 | 64.1 | 10.00 |
| 15 | ∞ | 0.00 | | | 10.00 |
| Image Plane | ∞ | | | | |

ASPHERIC DATA
1st Surface
K = 0.00000e+00 A4 = 3.11162e−05 A6 = 1.05670e−04 A8 = −3.66147e−06
2nd Surface
K = 0.00000e+00 A4 = 3.87022e−05 A6 = 4.03111e−05
3rd Surface
K = 0.00000e+00 A4 = −1.31161e−03 A6 = −2.84377e−04 A8 = −6.06880e−06
A10 = 1.12407e−07
4th Surface
K = 0.00000e+00 A4 = −5.36099e−04 A6 = −3.08553e−04 A8 = −1.18226e−07
5th Surface
K = 0.00000e+00 A4 = 2.55938e−04 A6 = 4.45923e−05 A8 = 4.95630e−07
A10 = −1.08627e−07
6th Surface
K = 0.00000e+00 A4 = −5.36099e−04 A6 = −3.08553e−04 A8 = −1.18226e−07
7th Surface
K = 0.00000e+00 A4 = −1.31161e−03 A6 = −2.84377e−04 A8 = −6.06880e−06
A10 = 1.12407e−07
8th Surface
K = 0.00000e+00 A4 = 3.87022e−05 A6 = 4.03111e−05
9th Surface
K = 0.00000e+00 A4 = −1.31161e−03 A6 = −2.84377e−04 A8 = −6.06880e−06
A10 = 1.12407e−07
10th Surface
K = 0.00000e+00 A4 = −5.36099e−04 A6 = −3.08553e−04 A8 = −1.18226e−07
11th Surface
K = 0.00000e+00 A4 = 2.55938e−04 A6 = 4.45923e−05 A8 = 4.95630e−07
A10 = −1.08627e−07
13th Surface (Diffractive surface)
Designed Wavelength: 0.58756 [μm]
U2 = −1.73168e−01 U4 = 3.37949e−04 U6 = 7.44346e−05 U8 = −2.93620e−06 U10 =
2.85092e−08

OPTICAL PATH DIFFERENCE DISPERSION OF SURFACE
1/ν₀ = 0
P(λ) = 0.58756/2
P(λ_{d}) = 1.000000e+00
P(λ_{C}) = 8.953022e−01
P(λ_{F}) = 1.208648e+00

VARIOUS DATA

| | |
|---|---|
| Focal Length | 4.00 |
| Fno | 0.80 |
| Half Angle of View (°) | 35.18 |
| Image Height | 2.82 |
| Overall Lens Length | 4.96 (in Air) |
| BF | 1.53 (in Air) |
| Entrance Pupil Position | 0.00 |
| Exit Pupil Position | 7.48 |
| Front Principal-Point Position | 6.14 |
| Rear Principal-Point Position | −4.00 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 4.00 | 5.00 | 6.14 | −4.00 |

SINGLE LENS DATA

| Lens | Starting Surface | Focal Length |
|---|---|---|
| 1 | 1 | −60.83 |
| 2 | 3 | 30.74 |
| 5 | 11 | −15.73 |
| 6 | 12 | 2.89 |
| CG | 14 | 0.00 |

NUMERICAL EXAMPLE 7
UNIT: mm
SURFACE DATA

| Surface No. | r | d | nd | νd | Effective Diameter |
|---|---|---|---|---|---|
| 1 (SP) | ∞ | 0.50 | 1.45867 | 67.9 | 24.79 |
| 2 (diffraction) | ∞ | 0.84 | | | 24.79 |
| 3 | 20.508 | 2.25 | 1.59551 | 39.2 | 20.47 |
| 4 | 31.689 | 2.16 | | | 19.27 |
| 5* | 10.215 | 2.66 | 1.54390 | 56.0 | 14.19 |
| 6* | 8.799 | 1.60 | | | 11.89 |
| 7 | 51.373 | 4.28 | 1.72047 | 34.7 | 10.64 |
| 8 | 10.184 | −4.28 | | | 5.50 |
| 9 | 51.373 | −1.60 | | | 5.65 |
| 10* | 8.799 | −2.66 | 1.54390 | 56.0 | 5.62 |
| 11* | 10.215 | −2.16 | | | 6.64 |
| 12 | 31.689 | 2.16 | | | 7.29 |
| 13* | 10.215 | 2.66 | 1.54390 | 56.0 | 6.79 |
| 14* | 8.799 | 1.60 | | | 5.87 |
| 15 | 51.373 | 4.28 | 1.72047 | 34.7 | 5.55 |
| 16 | 10.184 | 0.91 | | | 4.69 |
| 17* | 7.085 | 1.20 | 1.67000 | 19.4 | 4.69 |
| 18* | 10.281 | 1.16 | | | 5.27 |
| 19* | −3.784 | 1.65 | 1.54390 | 56.0 | 5.26 |
| 20* | −8.550 | 0.50 | | | 6.00 |
| 21 | ∞ | 0.30 | 1.51633 | 64.1 | 10.00 |
| 22 | ∞ | 0.00 | | | 10.00 |
| Image Plane | ∞ | | | | |

ASPHERIC DATA
2nd Surface (Diffractive surface)
Designed Wavelength: 0.58756 [μm]
U 2 = −2.65530e−02 U4 = 2.90505e−05 U6 = −6.86760e−08 U8 = 1.36253e−10 U10 = −1.21830e−13

OPTICAL PATH DIFFERENCE DISPERSION OF SURFACE
1/ν₀ = 0
P(λ) = 0.58756/λ
P(λ_{d}) = 1.000000e+00
P(λ_{C}) = 8.953022e−01
P(λ_{F}) = 1.208648e+00

5th Surface
K = 0.00000e+00 A4 = −9.62169e−05 A6 = −2.08297e−07 A8 = 5.98344e−09
A10 = −3.57905e−10
6th Surface
K = 0.00000e+00 A4 = −6.56587e−04 A6 = −3.21660e−06 A8 = 1.51282e−08
10th Surface
K = 0.00000e+00 A4 = −6.56587e−04 A6 = −3.21660e−06 A8 = 1.51282e−08
11th Surface
K = 0.00000e+00 A4 = −9.62169e−05 A6 = −2.08297e−07 A8 = 5.98344e−09
A10 = −3.57905e−10
13th Surface
K = 0.00000e+00 A4 = −9.62169e−05 A6 = −2.08297e−07 A8 = 5.98344e−09
A10 = −3.57905e−10
14th Surface
K = 0.00000e+00 A4 = −6.56587e−04 A6 = −3.21660e−06 A8 = 1.51282e−08
17th Surface
K = 0.00000e+00 A4 = −1.30286e−02 A6 = −2.43684e−04 A8 = −1.07847e−04
18th Surface
K = 0.00000e+00 A4 = −1.49050e−02 A6 = 3.90560e−04 A8 = −3.68580e−05
19th Surface
K = 0.00000e+00 A4 = 1.20727e−03 A6 = −3.33745e−04 A8 = 5.26975e−05
20th Surface
K = 0.00000e+00 A4 = −1.42199e−02 A6 = 6.11571e−04 A8 = 1.61765e−05

VARIOUS DATA

| | |
|---|---|
| Focal Length | 69.40 |
| Fno | 2.80 |
| Half Angle of View (°) | 2.48 |
| Image Height | 3.00 |
| Overall Lens Length | 19.90 (in Air) |
| BF | 0.70 (in Air) |
| Entrance Pupil Position | 0.00 |
| Exit Pupil Position | −11.52 |
| Front Principal-Point Position | −348.65 |
| Rear Principal-Point Position | −69.40 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 69.40 | 20.00 | −348.65 | −69.40 |

SINGLE LENS DATA

| Lens | Starting Surface | Focal Length |
|---|---|---|
| 1 | 1 | 18.83 |
| 2 | 3 | 90.80 |
| 3 | 5 | −345.41 |
| 4 | 7 | −18.43 |
| 9 | 17 | 29.58 |
| 10 | 19 | −14.22 |
| CG | 21 | 0.00 |

NUMERICAL EXAMPLE 8
UNIT: mm
SURFACE DATA

| Surface No. | r | d | nd | νd | Effective Diameter |
|---|---|---|---|---|---|
| 1 | ∞ | 0.50 | 1.45867 | 67.9 | 12.39 |
| 2 (diffraction) | ∞ | 0.00 | | | 12.39 |
| 3 | ∞ | 10.12 | | | 4.00 |
| 4* | −43.204 | 1.17 | 1.49171 | 57.4 | 11.19 |
| 5* | −40.745 | −1.17 | | | 11.20 |
| 6* | −43.204 | −9.12 | | | 10.54 |
| 7* | −17.227 | 9.12 | | | 3.76 |
| 8* | −43.204 | 1.17 | 1.49171 | 57.4 | 2.83 |
| 9* | −40.745 | 0.90 | | | 3.10 |
| 10* | −3.574 | 0.50 | 1.54390 | 56.0 | 3.69 |
| 11* | 8.821 | 1.37 | | | 4.31 |
| 12* | 6.791 | 2.20 | 1.58517 | 34.6 | 5.89 |
| 13* | −20.712 | 0.93 | | | 5.90 |
| 14 | ∞ | 0.30 | 1.51633 | 64.1 | 20.00 |
| 15 | ∞ | 0.00 | | | 20.00 |
| Image Plane | ∞ | | | | |

ASPHERIC DATA
2nd Surface (Diffractive surface)
Designed Wavelength: 0.58756 [μm]
U2 = −6.28884e−03 U4 = 1.57913e−05 U6 = 1.90677e−08

OPTICAL PATH DIFFERENCE DISPERSION OF SURFACE
1/ν₀ = 0
P(λ) = 0.58756/λ
P(λ_{d}) = 1.000000e+00
P(λ_{C}) = 8.953022e-01
P(λ_{F}) = 1.208648e+00
4th Surface
K = 0.00000e+00 A4 = −2.96836e−05 A6 = 6.97712e−07 A8 = −1.21276e−08
5th Surface
K = 0.00000e+00 A4 = −1.61527e−05 A6 = 1.90480e−07 A8 = −2.93181e−09
A10 = −4.24214e−12
6th Surface
K = 0.00000e+00 A4 = −2.96836e−05 A6 = 6.97712e−07 A8 = −1.21276e−08
7th Surface
K = 0.00000e+00 A4 = −9.38573e−05 A6 = −2.17370e−07
8th Surface
K = 0.00000e+00 A4 = −2.96836e−05 A6 = 6.97712e−07 A8 = −1.21276e−08
9th Surface
K = 0.00000e+00 A4 = −1.61527e−05 A6 = 1.90480e−07 A8 = −2.93181e−09
A10 = −4.24214e−12
10th Surface
K = 0.00000e+00 A4 = 7.25779e−03
11th Surface
K = 0.00000e+00 A4 = 3.36181e−03
12th Surface
K = 0.00000e+00 A4 = 2.08687e−03
13th Surface
K = 0.00000e+00 A4 = 5.08988e−03 A6 = 1.15441e−04 A8 = −2.92779e−05

VARIOUS DATA

| | |
|---|---|
| Focal Length | 69.40 |
| Fno | 5.60 |
| Half Angle of View (°) | 2.48 |
| Image Height | 3.00 |
| Overall Lens Length | 17.90 (in Air) |
| BF | 1.13 (in Air) |
| Entrance Pupil Position | 51.54 |
| Exit Pupil Position | −14.60 |
| Front Principal-Point Position | −208.86 |
| Rear Principal-Point Position | −69.40 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 69.40 | 18.00 | −208.86 | −69.40 |

SINGLE LENS DATA

| Lens | Starting Surface | Focal Length |
|---|---|---|
| 1 | 1 | 79.51 |
| 2 | 4 | 1258.33 |
| 5 | 10 | −4.61 |
| 6 | 12 | 9.01 |
| CG | 14 | 0.00 |

NUMERICAL EXAMPLE 9
UNIT: mm
SURFACE DATA

| | | | | | | Effective |
|---|---|---|---|---|---|---|
| Surface No. | r | d | nd | νd | Azimuth | Diameter |
| 1 | ∞ | 0.50 | 1.45867 | 67.9 | 0.0 | 5.20 |
| 2 (diffraction) | ∞ | 7.53 | | | 0.0 | 5.02 |
| 3 (Reflection) | FFS | −6.53 | | | −25.0 | 4.68 |
| 4 (Reflection) | FFS | 10.99 | | | −20.0 | 5.38 |
| 5* | 6.105 | 0.50 | 1.66691 | 19.6 | 0.0 | 7.12 |
| 6* | 4.522 | 0.23 | | | 0.0 | 6.81 |
| 7* | 4.582 | 2.03 | 1.54390 | 56.0 | 0.0 | 6.91 |
| 8* | 19.200 | 0.84 | | | 0.0 | 6.78 |
| 9 | ∞ | 0.40 | 1.51633 | 64.1 | 0.0 | 10.00 |
| 10* | ∞ | 0.00 | | | 0.0 | 10.00 |
| Image Plane | ∞ | | | | | |

ASPHERIC DATA
2nd Surface (Diffractive surface)
Designed Wavelength: 0.58756 [μm]
U 2 = −1.45535e−02 U4 = 2.85585e−05 U6 = −2.47330e−07
OPTICAL PATH DIFFERENCE DISPERSION OF SURFACE
1/ν₀ = 0
P(λ) = 0.58756/λ
P(λ_{d}) = 1.000000e+00
P(λ_{C}) = 8.953022e−01
P(λ_{F}) = 1.208648e+00

### Freeform Surface

“FFS” indicates that a surface having a freeform shape. The freeform shape is expressed by the following equation:

$$x = C 02 \cdot {Z}^{2} + C 04 \cdot {Z}^{4} + C 20 \cdot {Y}^{2} + C 22 \cdot {Y}^{2} \cdot {Z}^{2} + C 24 \cdot {Y}^{2} \cdot {Z}^{4} + C 30 \cdot {Y}^{3} + C 32 \cdot {Y}^{3} \cdot {Z}^{2} + C 34 \cdot {Y}^{3} \cdot {Z}^{4} + C 40 \cdot {Y}^{4} + C 42 \cdot {Y}^{4} \cdot {Z}^{2} + C 44 \cdot {Y}^{4} \cdot {Z}^{4}$$

where x is a displacement amount from a surface vertex in the optical axis direction, Y and Z are the distances from the optical axis in the Y and Z directions of a plane orthogonal to the optical axis, and C20 to C44 are freeform surface coefficients. “e+M” in the free-form surface coefficients means×10^{±M}.

Azimuth is an angle between a plane and an optical axis incident on the origin of the freeform surface in a case where all freeform surface coefficients are set to 0.

3rd Surface
C 02 = −1.31302E−03 C 04 = −3.81789E−05
C 20 = −1.05275E−03 C 22 = −6.10650E−05 C 24 = −2.97892E−07
C 30 = −2.05445E−05 C 32 = −1.56703E−06 C 34 = −8.57809E−07
C 40 = −2.59432E−05 C 42 = −1.50453E−06 C 44 = 2.32575E−07
4th Surface
C 02 = 2.69410E−03 C 04 = −2.87723E−05
C 20 = 2.42249E−03 C 22 = −5.17626E−05 C 24 = 3.07669E−07
C 30 = −4.31712E−05 C 32 = −6.84351E−06 C 34 = −7.21633E−07
C 40 = −2.28556E−05 C 42 = −1.20457E−06 C 44 = 3.27461E−07

### (Rotationally Symmetrical Aspheric Surface)

(ROTATIONALLY SYMMETRICAL ASPHERIC SURFACE)

5th Surface
K = 0.00000e+00 A4 = 1.86068e−03 A6 = −1.02002e−04
6th Surface
K = 0.00000e+00 A4 = 3.26723e−03 A6 = −2.47320e−04
7th Surface
K = 0.00000e+00 A4 = 1.16271e−03 A6 = −1.57151e−04
8th Surface
K = 0.00000e+00 A4 = 4.02193e−05 A6 = −4.57636e−05

VARIOUS DATA

| | |
|---|---|
| Focal Length | 20.80 |
| Fno | 4.00 |
| Half Angle of View (°) | 8.21 |
| Image Height | 1.80 |

SINGLE LENS DATA

| Lens | Starting Surface | Focal Length |
|---|---|---|
| 1 | 1 | 34.36 |
| 2 | 5 | −29.93 |
| 5 | 7 | 10.55 |
| CG | 9 | 0.00 |

TABLE 1

| | Lower | Upper | Numerical Example | | | | |
|---|---|---|---|---|---|---|---|
| Inequality | Limit | Limit | 1 | 2 | 3 | 4 | 5 |
| (1) | −0.2 | 0.2 | 0.0033 | 0.0000 | 0.0250 | 0.0667 | −0.0104 |
| (2) | 0.01 | 5.00 | 2.141 | 0.974 | 0.284 | 0.177 | 0.095 |
| (3) | / | 10.0 | 1.232 | 0.036 | 1.812 | 3.559 | 7.736 |
| (4) | 0.1 | 1.1 | 0.449 | 0.682 | 0.930 | 1.036 | 1.072 |
| (5) | 0.1 | 1.4 | 0.392 | 0.425 | 0.903 | 1.218 | 1.214 |
| (6) | / | 1.0 | — | 0.0190 | 0.0885 | 0.5697 | 0.1607 |
| | | fm | 7.101 | 15.601 | −23.271 | 22.549 | 42.175 |
| | | fr | −5.762 | −436.934 | 12.841 | 6.335 | 5.452 |
| | | | M1 | M2 | M2 | M2 | M2 |
| | | D1 | 3.410 | 5.180 | 7.670 | 5.180 | 5.360 |

| | Lower | Upper | Numerical Example | | | |
|---|---|---|---|---|---|---|
| Inequality | Limit | Limit | 6 | 7 | 8 | 9 |
| (1) | −0.2 | 0.2 | 0.0000 | 0.0000 | 0.0000 | 0.0000 |
| (2) | 0.01 | 5.00 | 1.385 | 3.686 | 0.873 | 0.605 |
| (3) | / | 10.0 | 0.578 | 3.698 | 9.230 | — |
| (4) | 0.1 | 1.1 | 1.056 | 0.222 | 0.904 | — |
| (5) | 0.1 | 1.4 | 1.241 | 0.287 | 0.258 | — |
| (6) | / | 1.0 | 0.5969 | 0.0122 | 0.0094 | 0.0005 |
| | | fm | 2.887 | 18.830 | 79.506 | 34.356 |
| | | fr | 4.998 | −5.092 | −8.614 | — |
| | | | M1 | M1 | M2 | — |
| | | D1 | 5.280 | 5.500 | 11.200 | — |

### Image Pickup Apparatus

FIG. 20 illustrates a digital still camera as an image pickup apparatus that uses the optical system according to any one of the above-described examples as an imaging optical system. Reference numeral 20 denotes a camera body, and reference numeral 21 denotes an imaging optical system that includes any one of the optical systems according to Examples 1 to 9. Reference numeral 22 denotes an image sensor, such as a CCD sensor or a CMOS sensor, which is built into the camera body 20 and captures an optical image (that is, an object image) formed by the imaging optical system 21. Reference numeral 23 denotes a recorder that records image data generated by processing an imaging signal output from the image sensor 22, and reference numeral 24 denotes a rear display unit that displays the image data.

The optical system according to each example can provide a camera that has a reduced size and high optical performance. The camera may be a single-lens reflex camera having a quick-turn mirror, or may be a mirrorless camera not having a quick-turn mirror.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide an optical system having a reduced size and high optical performance by reducing the number of lenses and the overall optical length.

What is claimed is:

1. An optical system that reflects light from an object side by a first reflective surface and further reflects the light by a second reflective surface to guide the light to an image side,
wherein the optical system includes a diffractive surface having a controlled wavelength dispersion characteristic,
wherein in a case where the following equation is satisfied:
$$\frac{1}{{ν}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )}$$
where ν₀ is an Abbe number of the diffractive surface, a reference wavelength is d-line, principal dispersions are F-line and C-line, ψ(λ_{d}), ψ(λ_{F}), and ψ(λ_{C}) are optical path difference functions at the d-line, the F-line, and the C-line, and P(λ_{d}), P(λ_{F}), and P(λ_{C}) are surface optical path difference dispersions at the d-line, the F-line, and the C-line, the following inequality is satisfied:
$$- 0.2 < 1 / {ν}_{0} < 0.2 .$$

2. The optical system according to claim 1, wherein at least one of the first reflective surface and the second reflective surface includes a concave mirror and has positive optical power.

3. The optical system according to claim 1, wherein the following inequality is satisfied:
$$0.01 < f / \vert fm \vert < 5.$$
where f is a focal length of the optical system and fm is a focal length of the diffractive surface.

4. The optical system according to claim 1, wherein the following inequality is satisfied:
$$\vert fm / fr \vert < 10.$$
where fm is a focal length of the diffractive surface, and fr is a focal length of a reflective surface having strongest optical power among the first reflective surface and the second reflective surface.

5. The optical system according to claim 1, wherein the diffractive surface is disposed closer to an object than the first reflective surface, and
wherein the following inequality is satisfied:
$$0.1 < D 1 / ( f / Fno ) < 1.1$$
where D1 is an optical effective diameter of the first reflective surface, f is a focal length of the optical system, and Fno is an full aperture ratio of the optical system.

6. The optical system according to claim 1, wherein the following inequality is satisfied:
$$0.1 < OAL / f < 1.4$$
where OAL is an overall optical length of the optical system, and f is a focal length of the optical system.

7. The optical system according to claim 1, wherein the diffractive surface has positive optical power.

8. The optical system according to claim 1, wherein both the first reflective surface and the second reflective surface are transmissive reflective surfaces, and
wherein the light from the object side is guided to the image side so that the light transmits through the first reflective surface, is reflected by the second reflective surface, is reflected by the first reflective surface, and transmits through the second reflective surface.

9. The optical system according to claim 1, wherein the first reflective surface has a non-reflective portion that allows the light to pass therethrough, and
wherein the light from the object side is guided to the image side so that the light is reflected by the first reflective surface, is reflected by the second reflective surface, and passes through the non-reflective portion.

10. The optical system according to claim 1, wherein the optical system includes at least one refractive lens.

11. The optical system according to claim 10, wherein the refractive lens includes a positive lens and a negative lens.

12. The optical system according to claim 1, wherein the following inequality is satisfied:
$$1000 \times \vert \sum ( Φ i / ν di ) \vert / f < 1.$$
wherein among all refractive lenses included in the optical system, Φi is optical power of an i-th refractive lens counted from the object side, νdi is an Abbe number of the i-th refractive lens based on the d-line, Σ(Φi/νdi) is a sum of Φi/νdi over all refractive lenses, and f is a focal length of the optical system.

13. An optical system that reflects light from an object side by a first reflective surface and further reflects the light by a second reflective surface to guide the light to an image side,
wherein the optical system includes a metasurface having a controlled wavelength dispersion characteristic,
wherein in a case where the following equation is satisfied:
$$\frac{1}{{ν}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )}$$
where ν₀ is an Abbe number of the metasurface, a reference wavelength is d-line, principal dispersions are F-line and C-line, ψ(λ_{d}), (λ_{F}), and (λ_{C}) are optical path difference functions at the d-line, the F-line, and the C-line, and P(λ_{d}), P(λ_{F}), and P(λ_{C}) are surface optical path difference dispersions at the d-line, the F-line, and the C-line, the following inequality is satisfied:
$$- 0.2 < 1 / {ν}_{0} < 0.2 .$$

14. An image pickup apparatus comprising:
the optical system according to claim 1; and
an image sensor configured to capture an object through the optical system.
